(19) United States
(12) Patent Application Publication
(10) Pub. No.: US 2010/0044231 A1
(43) Pub. Date: Feb. 25, 2010

(54) LATERAL OPENING FOR FLUID INTRODUCTION

(75) Inventors: Stefan Falk-Jordan, Waldbronn (DE); Hans-Peter Zimmermann, Waldbronn (DE); Fritz Bek, Waldbronn (DE)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Santa Clara, CA (US)

(21) Appl. No.: 12/522,660

(22) PCT Filed: Jan. 17, 2007
(86) PCT No.: PCT/EP07/50448

§ 371 Date: Jul. 9, 2009

(51) Int. Cl. B01L 3/00; B01L 3/02; B01L 9/00; G01N 35/10; G01N 27/00

(52) U.S. Cl. 204/601; 422/70; 422/99

(57) ABSTRACT

A microfluidic chip (10) comprises a substrate (20) having a main side (30) and a lateral side (40), and a microfluidic channel (50, 60) within the substrate and being adapted to transport a fluid. The microfluidic channel has a lateral opening to the lateral side of the substrate allowing to introduce fluid to the microfluidic channel.

### BACKGROUND ART

The present invention relates to microfluidic chips.

In microstructure technology applications as in the Agilent 2100 Bioanalyzer, by the applicant Agilent Technologies, fluid may be conveyed through miniaturized channels (which may be filled with gel material) formed in a substrate. For a capillary electrophoresis device as an example for such a microstructure technology application, an electric field is generated in the fluid channels in order to allow for a transport of components of the fluid through the channels using electric forces. Such an electric force or field may be generated by dipping contact pins of the capillary electrophoresis device into the fluid which may be filled in a well defined by a carrier element coupled to a microfluidic chip, and by applying an electrical voltage to such contact pins.

WO 00/78454 A1, DE 19928412 A1, and U.S. Pat. No. 6,814,846 by the same applicant Agilent Technologies show different microfluidic chips and applications. Other microfluidic devices and applications are disclosed e.g. in WO 98/49548, U.S. Pat. No. 6,280,589, or WO 96/04547.

In most microfluidic applications, the microfluidic chip is coupled with a carrier (often also referred to as caddy), whereby the carrier forms wells (e.g. having a volume of 10-50 microliters) on top of the microfluidic chip allowing to supply fluid into the microfluidic channels and/or to apply electrodes or pressure supplies into the wells to drive the fluid through the channels.

### DISCLOSURE

It is an object of the present invention to provide and improved introduction of fluid into microfluidic chips. The object is solved by the independent claim(s). Further embodiments are shown by the dependent claim(s).

In one embodiment, the microfluidic chip has a substrate with a main side and a lateral side. The substrate comprises at least one microfluidic channel which is adapted to transport a fluid. The microfluidic channel has a lateral opening to the lateral side of the substrate, thus allowing to introduce fluid into the microfluidic channel.

By bringing the opening for fluid supply to the lateral side of the microfluidic chip, an entirely different layout of the microfluidic chip can be achieved. Embodiments of the invention thus allows to avoid openings on the main side of the chip, which usually requires drilling through at least a part of the microfluidic chip e. g. by using powder blasting, ultra sonic drilling, etc. In particular when using glass chips, such reduction or avoidance of drilled holes through glass can significantly reduce the effort and costs to produce glass chips.

Further, with the guiding of the chip openings to the lateral side of the chip, the chip size can be reduced as the application of top wells on or over the main side of the microfluidic chip usually requires a certain area to provide the wells in a technically feasible manner. Thus, the microfluidic channels can be packed closer together and also shorter channel path lengths can be achieved.

In case the microfluidic chip is comprised of two layers, e. g. glass plates, with the microfluidic channel(s) being formed in one layer and the other layer providing a top layer to close the channel(s), the provision of the lateral openings also reduces the effort to align the two plates during manufacturing, as the top plate does not necessarily require any structure (such as through-holes) which has to be aligned with the channel(s).

Embodiments of the invention also allow to access (e.g. for the purpose of detection) the microfluidic chip from both sides, in contrast to most embodiments as in the prior art, wherein for example a carrier is stacked on top of the microfluidic chip so that the top side of the microfluidic chip is covered by the carrier for supplying the microfluidic chip with the fluid. This allows e. g. providing detection systems, heaters, etc. directly to the microfluidic chip or the channels thereof.

In one embodiment, the microfluidic chip comprises a fluid supply which is coupled to the lateral opening, the fluid supply is provided to supply fluid to the microfluidic channel. Such lateral fluid supply, as illustrated above, allows avoiding fluid supply from the top (as the main side of the microfluidic chip) as known in the art.

In a preferred embodiment, the fluid supply comprises a well for receiving fluid and containing the fluid to supply the lateral opening. Such well might be any kind of well structure as known in the art, however, shifted from the top side of the microfluidic chip to its lateral side. Such well might be formed by a plastic material such as PE (Polyethylene), ABS (Acrylnitril/Butadien/Styrole), POM (Polyoxymethylene), PMMA (Polymethylmetacrylate), etc. While the well can be formed within or by the same material as the microfluidic chip, materials initially different from the chip material can be used as well. E.g. in case of glass material chips, the well might be formed by a plastic material.

In one embodiment, the well is provided by or supporting a flowing fluid. In such embodiment, the lateral opening might be coupled to a conduit (such as a capillary), wherein the fluid flows (i.e. the fluid is moved or in move).

Adhesive materials, form-coupling and/or force coupling might be applied to couple the well to the opening and/or chip.

Seal or sealing lids might be provided for fluidically sealing the well to the substrate.

In one embodiment, the substrate is received by or into a carrier, wherein the one or more wells are formed in or by the carrier.

In one embodiment, the fluid supply comprises a capillary which might be physically separate from the microfluidic chip. The capillary might be received into a carrier or other structure which couples the capillary to the lateral opening. Adhesive materials might be applied to couple the capillary to the opening. The capillary might then couple e.g. to a fluid reservoir to supply the chip with fluid.

In one embodiment, the fluid supply comprises a droplet structure which might be physically separate from the microfluidic chip. The droplet structure is provided to receive a fluid droplet and to retain such fluid droplet to the lateral opening e.g. by adhesion and/or capillary force. In one embodiment, the droplet structure has an aperture coupled to the lateral opening which guides the fluid droplet to the lateral opening. A fluid dispenser might be provided to dispense the droplet into the droplet structure. Pressure and/or vacuum might be applied for removing remaining or excessive fluid from the droplet structure or to rinse the droplet structure.

The term “lateral” with respect to a microfluidic chip can be understood as referring to such side extending to a lateral end of the main side of the microfluidic chip, with the area of the lateral side being much smaller and typically only a fraction of the area of the main side. While the lateral side is typically perpendicular (at least within a certain tolerance) to the main side, it is also possible to provide a certain inclination, or such inclination might result from a certain manufacturing process.

While the microfluidic channel is typically extending parallel to the area of the main side, the channel might also be inclined or having portions extending inclined and even perpendicular (i.e. in a direction parallel to the vector of the main side area). In a preferred embodiment, the microfluidic channel is extending mainly parallel to an area of the main side (or perpendicular to the area vector of the main side), meaning that the ratio of the channel length of such portions extending parallel to the main side is much greater than of such portions of the channel extending perpendicular to the main side.

In preferred embodiments, the microfluidic chip comprises a plurality of microfluidic channels each having a lateral opening to one of the lateral sides of the substrate.

The substrate might be embodied by two or more layers with the microfluidic channel or the microfluidic channels being formed e.g. in one of the layers, by two adjacent layers, or by a combination of those. The substrate might also be embodied by a three layers structure with the channels being formed e.g. by the middle layer, as known in the art.

The substrate might be of a glass material, a plastic material such as PS (Polystyrole), PC (Polycarbonate), etc, a ceramic material such as Yitriumdioxyde or any other suitable ceramic material, or any other suitable material as known in the art.

Preferably, the substrate is substantially flat shaped with the main side being the side with the largest area, typically the upper or lower side of the substrate. Typical channel widths of microfluidic channels can be in the range of 1-1000 micrometers and in particular 30-500 micrometers. A typical channel height can be in the range of 1-100 micrometers and in particular 10-30 micrometer.

The microfluidic chip is preferably adapted to provide an electrophoretic separation, a chromatographic separation, or both. Other functionalities based on or using such fluid separation might also be embodied on the chip or in separate devices or systems as part of a fluid process. The microfluidic chip typically comprises a separation path to separate different compounds of a sample fluid dissolved in a mobile phase of the fluid.

The microfluidic chip might be applied in a microfluidic system having a drive for causing the fluid to be transported in the microfluidic channel. Such drive might be or comprise a pressure source and/or an electrical source (e.g. for driving the electrophoretic separation). A detector might be provided for detecting the fluid or parts thereof in the microfluidic channel, e.g. before or after a separation process.

Embodiments of the invention can be partly or entirely embodied or supported by one or more suitable software programs, which can be stored on or otherwise provided by any kind of data carrier, and which might be executed in or by any suitable data processing unit.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawing(s). Features that are substantially or functionally equal or similar will be referred to by the same reference sign(s).

FIG. 1 shows a microfluidic chip 10 according to an embodiment of the present invention.

FIG. 2 shows an embodiment of the microfluidic chip 10 having a lateral fluid supply in form of wells.

FIG. 3 shows another exemplary embodiment of the microfluidic chip, wherein the fluids supply to the lateral opening is provided by a capillary 300.

FIG. 4 shows another exemplary embodiment for a fluid supply using a droplet structure 400.

FIG. 6 illustrates another embodiment of the carrier 200.

FIG. 7 shows a solution to reduce or avoid creeping of fluid between neighboring wells due to capillary forces between the carrier 200 and the chip 10.

FIG. 8 shows another embodiment of the microfluidic chip 10.

FIG. 9 illustrates an embodiment having a well 900 which is streamed through by a flowing medium as indicated by the arrows.

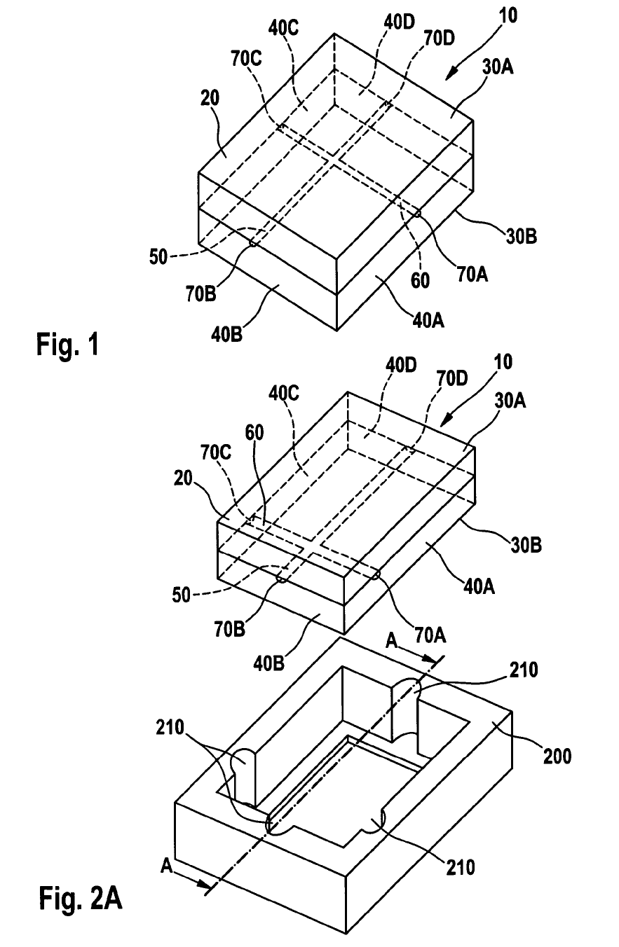

In FIG. 1, the microfluidic chip 10 has a substrate 20 having two main sides 30A and 30B and four lateral sides 40A, 40B, 40C and 40D. The microfluidic chip 10 in the exemplary embodiment of FIG. 1 is substantially flat shaped, so that the area of each main side (e.g. 30A) is much larger than the area of each lateral side (e.g. 40A).

In the example of FIG. 1, the substrate 20 comprises two microfluidic channels 50 and 60, each being adapted to conduct a fluid. In the example of FIG. 1, the two microfluidic channels 50 and 60 are intersecting each other and might be used for an electrophoretic separation, whereby e.g. channel 50 is used as a supply path and channel 60 as a separation path. In such embodiment, fluid might be transported along the channel 50, and at a certain timing only the portion (the so called fluid plug) currently located in the intersection part of the channels 50 and 60 is drawn into the separation path 60, and different components of the fluid plug drawn from the intersection are separated during movement along the separation path of the channel 60. Such technique is well known in the art and described in detail e.g. in the prior art as referred to in the introductory part of the description.

The microfluidic chip 10 in FIG. 1 has four lateral openings 70A, 70B, 70C and 70D to the lateral sides 40 of the substrate 20. At least one of the lateral openings 70 is provided to introduce fluid into at least one of the microfluidic channels of the substrate 20. In the example as above with channel 50 being a supply path and channel 60 representing a separation path, the lateral opening 70B is provided to introduce fluid into the channel 50, and any of the lateral openings 70A-70D might be provided for allowing to couple in fluid drives to drive the fluid through the channels 50 and 60. Such fluid drives might be electrodes (not shown in FIG. 1) coupling to the respective opening 70A-70D allowing to set up an electrical field for moving charged particles of the fluid along the channels 50 and 60.

The channels 50 and 60 in the example of FIG. 1 are filled with a gel substance as well known in the art of electrophoresis.

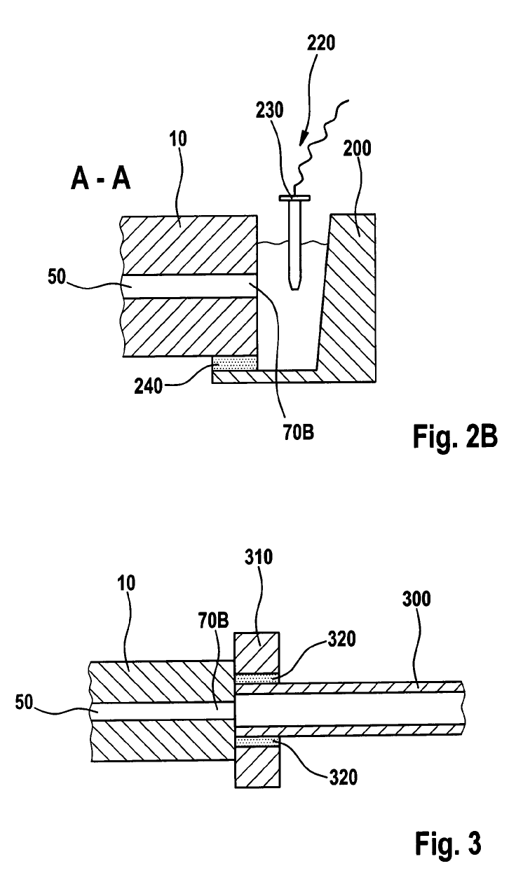

In the embodiment of FIG. 2A, the microfluidic chip 10 (which might be embodied as the example of FIG. 1 as indicated in FIG. 2A) is placed into a carrier 200. The carrier 200 has some lateral shapings 210 at its inner side into which the microfluidic chip 10 is placed into, so that when the microfluidic chip 10 is inserted into the well 200, the shapings 210 together with the outer walls of the substrate form wells 220 (see FIG. 2B).

FIG. 2B shows in a sectional view along line A-A an exemplary embodiment of the well 220. The carrier 200 attaches to the microfluidic chip 10, and the shaping 210 of the carrier 200 forms the well 220. The microfluidic channel (here: channel 50) is opening into the well 220 via the opening 70B, so that fluid contained into the well 220 is or can be introduced into the channel 50.

In the example of FIG. 2B, an electrode 230 is introduced into the well 220 thus allowing applying an electrical potential to the well 220 in order to move the fluid through the microfluidic channels. As can also seen from the example of FIG. 2B that the well 220 might be shaped so that the opening of the channel 50 is somewhat higher than the ground level of the well 220. This can be used to avoid that larger particles are drawn into the channel 50 but “sink down” to the ground level of the well 220.

The carrier 200 might be attached to the chip 10, or vice versa, e.g. by using an adhesive 240 between adjacent surfaces of the chip 10 and the carrier 200. However, any other way of coupling the chip 10 to the well 200 might be applied as well, e.g. using sealings, press fittings or form fittings.

In FIG. 3, the capillary 300 is coupling directly to the lateral opening 70B of the microfluidic chip 10. The capillary 300 might be mechanically supported by a holder 310 to provide sufficient mechanical stability to the coupling of the capillary 300 to the microfluidic chip 10. The capillary 300 might be coupled with the holder 310 e.g. by using adhesive 320 between adjacent surfaces of the capillary 300 and the holder 310, as indicated in the exemplary embodiment of FIG. 3. The other end 330 of the capillary might be coupled to a fluid container (not shown in the Figures) thus allowing to supply fluid into the microfluidic channels of the microfluidic chip 10. The capillary 300 might also be bent thus allowing to couple to fluid containers having e.g. a vertical opening.

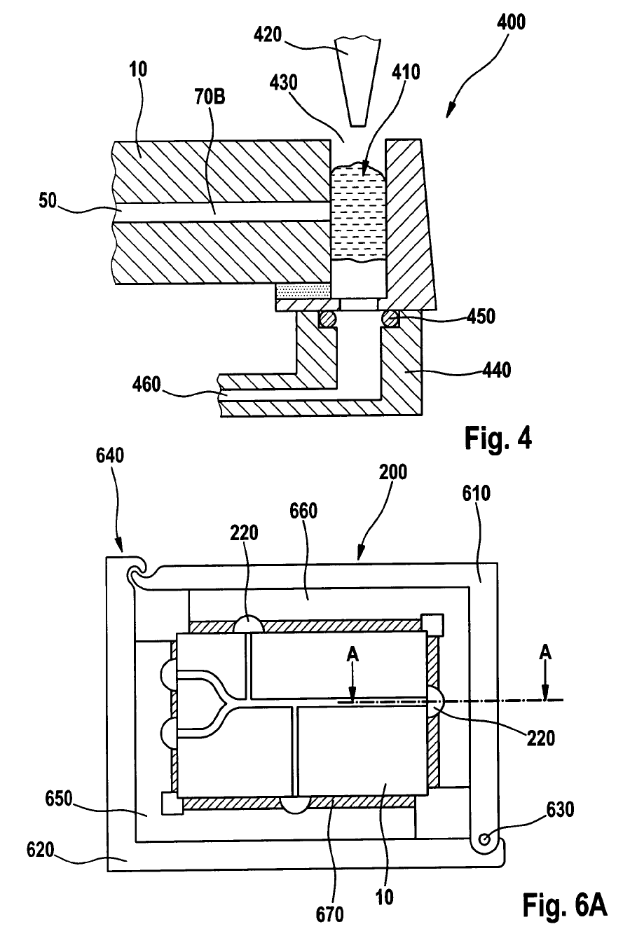

In FIG. 4, the droplet structure 400 is provided to receive a fluid droplet (indicated as reference numeral 410), e.g. from a pipette 420 or any other suitable device, and to retain (at least temporarily) the fluid droplet 410 to the lateral opening 70B. In the embodiment of FIG. 4, the droplet 410 is retained to the lateral opening 70B by adhesion force. The droplet structure 400 as in the embodiment of FIG. 4 comprises a vertical (with respect to the channel 50) through-hole 430 into which the channel 50 with its lateral opening 70B is opening to. Dimensioning of the through-hole 430 in order to keep the droplet 410 within the through-hole 430 and close to the lateral openings 70 is well known in the art and need not be discussed here in detail.

In order to remove excessive fluid from the through-hole 430 or to clean or rinse the through-hole 430, a conduit structure 440 might be coupled to the through-hole 430, e.g. using a sealing ring 450. By either applying pressure at the top opening of the through-hole 430 or an underpressure (vacuum) e.g. at an opening 460 of the structure 440, fluid in the through-hole 430 can be removed, and a new droplet 410 might be applied successively.

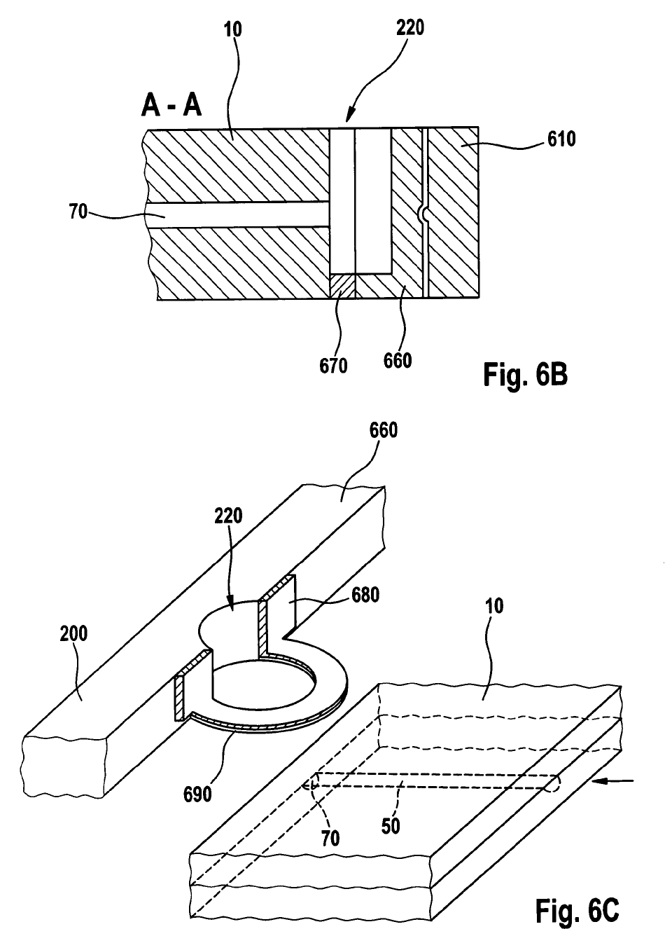

In the example of FIG. 6A the microfluidic chip 10 is introduced into the carrier 200 as illustrated before with respect to FIG. 2. However, while the carrier 200 in the embodiment of FIG. 2 is substantially ring shaped, the carrier 200 in FIG. 6A comprises to halves 610 and 620 hinged by a hinge 630 allowing to open and to close the carrier 200. A closing mechanism 640 might be provided at the ends of the halves 610 and 620 at the other end with respect to the hinge 630. The closing structure 640 might use any structure as known in the art (e.g. using form fitting or force fitting) in order to allow closing the two halves 610 and 620. The closing structure 640 might be provided to reversibly closing and opening the carrier 200, but might also be provided to only close the carrier 200 once. In one embodiment, as indicated in FIG. 6A, the carrier 200 is provided by two halves 650 and 660, and the halves 620 and 610 are parts external of the carrier. The halves 610 and 620 provide a clamping or locking ring in order to securely clamp or lock the carrier with the microfluidic chip 10.

FIG. 6B shows in greater detail a cross sectional view along line A-A. As can be seen from FIG. 6B, the clamping half 610 clamps and securely holds the carrier half 660 attached to the microfluidic chip 10, thus forming the well 220. A sealing lid 670 might be provided to couple the carrier 200 with the chip 10 in a fluid tight manner. Such sealing lid 670 might be made of silicone or any other suitable material as known in the art. As indicated in FIG. 6A the sealing lid 670 is surrounding the chip 10, but might also be provided by individual sections.

FIG. 6C shows another embodiment illustrating a mechanism for sealing the carrier (here carrier half 660) against the microfluidic chip. The sealing lid 680 (different from the sealing lid 670 as shown in FIGS. 6A and 6B) is attached to the carrier 200 in the region of the well 220. In this embodiment, the carrier 200 has a shaping 690 around the well 220. The sealing lid 680 is attached to the carrier 200 and onto the shaping 690 in order to fluidically seal the well 220 against the chip 10 once the chip 10 is attached against the carrier 200 as indicated by the arrow in FIG. 6C.

In other embodiments of a chip carrier assembly, a shrinking process might be used to assemble the chip 10 with the carrier 200. For such purpose, the carrier 200 might be heated, the chip 10 is pressed into the heated carrier 200 when cooling down, and the carrier shrinks onto the chip 10. Alternatively, the carrier 200 might also be molded or die-casted directly to the chip 10.

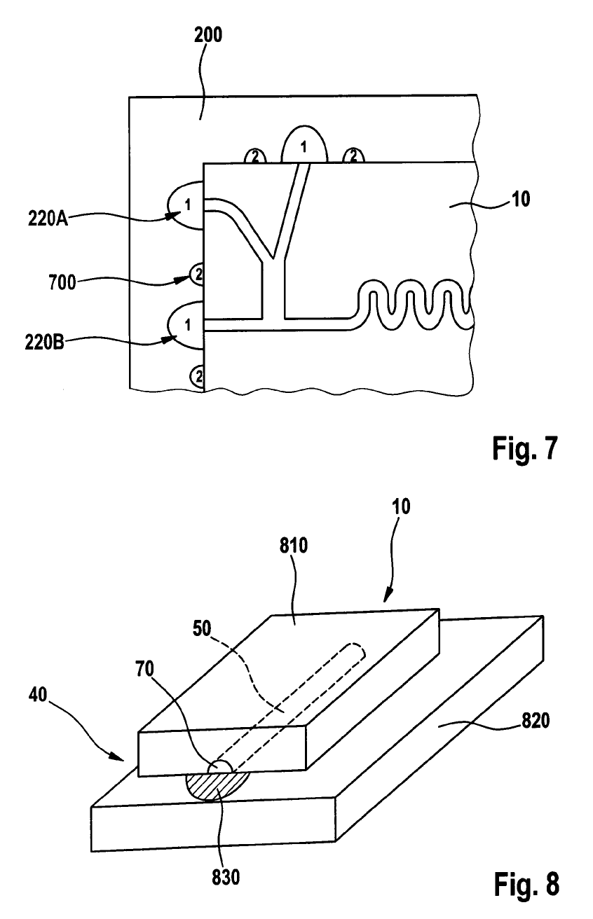

In FIG. 7, a vertical (with respect to the channel orientation) opening 700, which might be a through-hole, is provided between the neighboring wells 220A and 220B to reduce or avoid leakage or creeping of fluid between neighboring wells due to capillary forces between the carrier 200 and the chip 10. The opening 700 is opening towards the chip 10. Fluid which is creeping e.g. from the well 220A towards the well 220B along the “parasitic channel” between the side walls of the chip 10 and the carrier 200 is stopped from creeping by capillary force as soon as it reaches the opening 700. As the opening represents a much wider opening between the carrier 200 and the chip 10, the capillary force is “shortcut” and the leakage flow is stopped. Thus, an electrophoretic shortcut between neighboring wells can be avoided.

FIG. 8 illustrates that the term “lateral” does not require a clean cut surface but also encompasses e.g. a step shape structure as illustrated in FIG. 8. In this embodiment, the microfluidic chip 10 is comprised of two layers 810 and 820, with layer 810 sitting on top of layer 820. The channel 50 is formed by an indentation into either layer 810 or layer 820, or into both. In contrast to the embodiment of FIG. 1, the layer 820 in FIG. 8 is overlapping the layer 810, so that the lateral side 40 of the microfluidic chip 10 has a step shape. Wells might be formed to the microfluidic chip 10 in accordance with the above said. Alternatively or in addition, a hydrophilic surface 830 might be provided close to the opening 70, so that a fluid droplet placed in front of the opening 70 is retained at the hydrophilic surface 830.

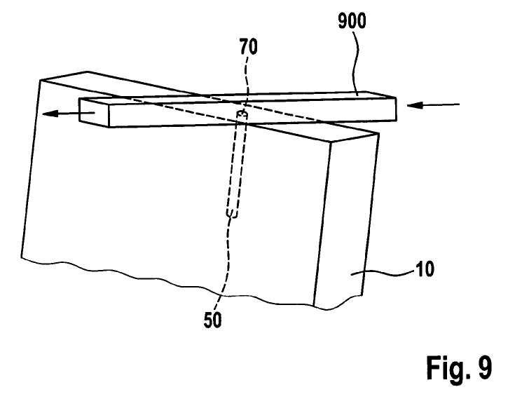

In FIG. 9, the well 900 which is streamed through by a flowing medium as indicated by the arrows. The opening 70 is coupling to the well 900 wherein the fluid is flowing. This allows drawing in samples of the flowing fluid, e.g. to provide a continuous fluid monitoring.

1. A microfluidic chip comprising
a substrate having a main side and a lateral side, and
a microfluidic channel within the substrate and being adapted to transport a fluid,
wherein the microfluidic channel has a lateral opening to the lateral side of the substrate allowing to introduce fluid to the microfluidic channel.

2. The microfluidic chip of claim 1, comprising
a fluid supply coupled to the lateral opening, wherein the fluid supply is adapted for supplying fluid to the microfluidic channel.

3. The microfluidic chip of claim 2, wherein the fluid supply comprises at least one of:
a well adapted for receiving fluid and containing the fluid to supply the lateral opening;
a capillary adapted to be coupled to a fluid container;
a droplet structure adapted to receive a fluid droplet and to retain the fluid droplet to the lateral opening by at least one of adhesion and capillary force.

4. The microfluidic chip of claim 3, wherein the fluid supply comprises the well, comprising at least one of:
the well is formed by a plastic material, preferably at least one of PE, ABS, POM, and PMMA;
the well is formed by a material different from the material of the microfluidic chip;
the well is formed at the lateral side of the microfluidic chip;
the well is adapted to support a flowing fluid,
at least one of a seal and a sealing lid for fluidically sealing the well to the substrate;
a carrier adapted to receive the substrate, wherein the well is formed in or by the carrier.

5. The microfluidic chip of claim 3, wherein the fluid supply comprises the capillary, comprising at least one of:
the capillary is a device physically separate from the microfluidic chip;
a carrier adapted to receive the capillary and to couple the capillary to the lateral opening, wherein preferably the capillary is coupled to the carrier by adhesive.

6. The microfluidic chip of claim 3, wherein the fluid supply comprises the droplet structure, comprising at least one of:
the droplet structure is a device physically separate from the microfluidic chip;
the droplet structure has an aperture coupled to the lateral opening to guide the fluid droplet to the lateral opening.

7. The microfluidic chip of claim 1, comprising at least one of:
an area of the lateral side is only a fraction of an area of the main side;
the lateral side is substantially perpendicular to the main side;
the microfluidic channel is extending mainly parallel to an area of the main side;
a plurality of microfluidic channels, each having a lateral opening to one of the lateral sides of the substrate allowing to introduce fluid to the respective microfluidic channel;
the substrate is of one of the materials from a list comprising: glass material, a plastic material, a ceramic material;
the substrate comprises at least two layers, with the microfluidic channel being formed in one of the layers or by two adjacent layers;
the substrate comprises two glass plates being attached to each other, with the microfluidic channel being formed in at least one of the glass plates;
the substrate is substantially flat shaped;
the microfluidic comprises two layers which are at least partly displaced from each other thus forming a step at the lateral side, wherein preferably the lateral opening opens in the bend of the step;
the microfluidic channel has a width in a range of 1-1000 μm, preferably 30-500 μm, and a height in the range of 1-100 μm, preferably 10-30 μm.

8. The microfluidic chip of claim 1, comprising at least one of:
the microfluidic chip is adapted to provide at least one of an electrophoretic and a chromatographic fluid separation;
the microfluidic chip comprises a separation path to separate different compounds of a sample fluid dissolved in a mobile phase of the fluid.

9. A microfluidic system comprising the microfluidic chip of claim 1, the microfluidic system comprising at least one of:
a drive for causing the fluid to be transported in the microfluidic channel, wherein the drive preferably comprises at least one of a pressure and an electrical source;
a detector for detecting the fluid being or having been transported in the microfluidic channel;
the microfluidic system is adapted to provide at least one of an electrophoretic and a chromatographic fluid separation on the microfluidic chip.
